(19) United States
(12) Patent Application Publication
(10) Pub. No.: US 2010/0257785 A1
(43) Pub. Date: Oct. 14, 2010

(54) SLIDE HANDLE

(76) Inventors: Keith James Chaston, Moorooka (AU); Steven Harrison, Coorparoo (AU)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(21) Appl. No.: 12/756,527

(22) Filed: Apr. 8, 2010

(30) Foreign Application Priority Data
Apr. 8, 2009 (AU) 2009901522

(51) Int. Cl. E06B 7/086

(52) U.S. Cl. 49/79.1

(57) ABSTRACT

A louvre window actuation system for a louvre window having a plurality of louvre blades and at least one operating bar associated with each of the louvre blades for movement thereof, the actuation system including a slidable handle movable between a closed condition in which the plurality of louvre blades are closed and a number of open conditions wherein the plurality of louvre blades are at least partially open wherein the slidable handle is operatively associated with the at least one operating bar to actuate the plurality of louvre blades.

### RELATED APPLICATION

The present application claims priority Australian Application No. 2009901522 filed Apr. 8, 2009, which is incorporated herein in its entirety by reference.

### FIELD OF THE INVENTION

The present invention relates generally to the field of louvre window systems and particularly to actuation systems for opening and closing a louvre window system. The present invention may also find application in other window or closure systems such as shutters for example.

### BACKGROUND ART

When screening a louvre window there is a choice of placing the screen to the outside or inside of the window frame.

Screening to the inside of the frame has advantages that the screen can be easily removed for cleaning from the inside of the building. This has convenience and safety benefits, particularly when the window is above ground level.

With an inside screen the handle needs to pass around or through the screening. This means the handle slot that is created becomes a weak point for insects getting through or around the screen.

Current handle mechanisms rely on an arced travel to create sufficient leverage on the mechanism that drives open the louvre blades. This arc can protrude into the living space and can be a safety concern as the handle can be a danger to passing human traffic.

The mechanics of the handle arc also results in inconsistent ergonomics. Where on the more common outside screen frame the handle finishes in the up position when closed and down position when open. Handles on traditional inside screen frames are the opposite and can cause confusion to the operator.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to a louvre window actuation system and a louvre window system including the actuation system, which may at least partially overcome at least one of the abovementioned disadvantages or provide the consumer with a useful or commercial choice.

With the foregoing in view, the present invention in one form, resides broadly in a louvre window actuation system for a louvre window having a plurality of louvre blades and at least one operating bar associated with each of the louvre blades for movement thereof, the actuation system including a slidable handle movable between a closed condition in which the plurality of louvre blades are closed and a number of open conditions wherein the plurality of louvre blades are at least partially open wherein the slidable handle is operatively associated with the at least one operating bar to actuate the plurality of louvre blades.

In a further form, the invention resides in a louvre window actuation system for a louvre window system having a plurality of louvre blades, at least one operating bar associated with each of the louvre blades for movement thereof, and a jamb relative to which the louvre blades, and the at least one operating bar are mounted, the jamb also including at least one mounting portion for mounting an internally mounted fly screen, the actuation system including a slidable handle movable between a closed condition in which the plurality of louvre blades are closed and a number of open conditions wherein the plurality of louvre blades are at least partially open, the slidable handle operatively associated with the at least one operating bar to actuate of the plurality of louvre blades wherein the slidable handle is located further internally of the louvre window system than the at least one mounting portion for an internally mounted fly screen.

In yet a further form, the invention resides in a louvre window system including
a) a plurality of louvre blades,
b) at least one operating bar associated with each of the louvre blades for movement thereof;
c) a slidable handle movable between a closed condition in which the plurality of louvre blades are closed and a number of open conditions wherein the plurality of louvre blades are at least partially open, the slidable handle operatively associated with the at least one operating bar to actuate of the plurality of louvre blades;
d) a jamb adapted to mount the louvre blades, the at least one operating bar and a slidable handle, the jamb also having at least one mounting portion for mounting an internal fly screen on an internal side of the window system;
   wherein the slidable handle is located further internally of the louvre window system than the at least one mounting portion for an internally mounted fly screen.

For the purpose of the present discussion, the following definitions will be adhered to:
Head—The horizontal part of the main window frame at the top of the window.
Main Frame—Comprised of the head, sill and jambs of a window.
Mullion—A vertical or horizontal connecting unit that divides windows and doors.
Sill—The horizontal, bottom part of the window frame.
Jambs—The vertical parts of the frame on both sides of the window.

A conventional louvre window system includes a main frame comprising the head, sill and jambs with a plurality of louvre blades extending substantially parallel to the sill and head.

The louvre blades are mounted in end clips.

The jamb of a louvre window system typically includes or has attached thereto, a substantially U-shaped channel into which are typically mounted a pair of slidable operating bars. Each operating bar is provided with a number of portions of tooth profile which each engage a gear which is provided in association with each louvre blade end clip. Therefore, movement of the operating bars will then normally drive rotation of the gear which in turn opens and closes the louvre blades.

A link member is typically provided through the substantially U-shaped channel in which the operating bars are located. Normally, this link member engages both the handle and at least one of the operating bars. The link member may directly engage at least one of the operating bars. The link member may be pivotally mounted in order to move the at least one operating bar when the handle is moved. Normally this pivoting movement is provided such that when the handle is moved downward, the louvres open.

The louvre blades, end clips and operating bars of the present invention are relatively unchanged from those used in conventional louvre window systems.

However, where in a conventional louvre window system the operating bars are driven between the open and closed conditions by movement of a handle with an arced travel to create sufficient leverage on the mechanism, the louvre window actuation system of the present invention includes a handle which slides in a reciprocating movement between the open and closed conditions.

The jamb of the louvre window system of the preferred embodiment will typically include an opening in an internally facing portion of the jamb through which a portion of the handle mechanism protrudes. An internal handle adapted for gripping is typically provided adjacent to the internally facing portion of the jamb.

The internal handle may have any configuration but is particularly preferred that the handle have a relatively small projection into the room. The handle of the present invention may therefore be a foldable handle or the like which allows the handle to be folded to overlie a portion of the jamb (or even be received into a recess in the jamb) in order to minimise intrusion into the room space. Alternatively, the handle may be a fixed handle.

There will typically be a slidable actuation mechanism located at least partially within the jamb of the window system. The preferred louvre window system of the present invention is one adapted for mounting a fly screen on an internal or room side of the louvre window assembly. As discussed above, this configuration is often used in high-rise buildings so that the fly screen is accessible from inside the room rather than from the exterior of the window system which may be less accessible on such a high-rise building.

The jamb of the window system of the present invention will therefore typically include a main mounting member which is adapted to be mounted adjacent the periphery of the opening into which the window system is to be secured, a substantially U-shaped channel member which is adapted to engage with the main mounting member and which will typically mount the louvre end clips and operating bars, and a fly screen mounting portion spaced inwardly from the substantially U-shaped channel, typically by separation distance which is at least as large as half the height of a louvre blade or end clip to provide clearance to open the louvre window.

The substantially U-shaped channel and the fly screen mounting portion are preferably mounted on the same side of the main mounting member.

The slidable actuation mechanism of the present invention is typically located between the substantially U-shaped channel member and the fly screen mounting portion of the jamb. Preferably, the slidable actuation mechanism will be substantially parallel to a portion of the main mounting member which separates the substantially U-shaped channel member and the fly screen mounting portion.

According to a particularly preferred embodiment, the slidable actuation mechanism includes a main or body portion and a clamping member. These members may have any shape or configuration. Preferably, the main or body portion is positioned to abut an internal surface of the internally facing portion of the jamb directly adjacent, and typically over, the opening provided in the jamb which allows movement of the handle. In this way, the main or body portion of the actuation mechanism will also act to cover or seal the opening provided in the jamb which will typically decrease the opportunity for ingress of insects or water, for example, through the jamb and into the room through this opening.

Preferably, the fly screen mounting portion may act as a guide portion for the main or body portion of the actuation mechanism. According to a particularly preferred embodiment, the fly screen mounting portion is adapted to mount a fly screen substantially perpendicularly to the jamb of the window system. The fly screen mounting portion is preferably spaced from the main body portion of the mounting member which separates the substantially U-shaped channel member and the fly screen mounting portion from one another. Preferably, a portion of the main or body portion is received into the space defined between the fly screen mounting portion and the main body portion of the mounting member of the jamb. Typically, the portion received in the space is received in interference to fit in order to guide the movement of the main body portion.

It is further preferred that the fly screen mounting portion (or the main body portion of the mounting member) may be provided with guide means which will engage with corresponding guide means provided on the main or body portion of the actuation mechanism in order to limit the movement of the main body portion of the actuation mechanism to a single plane, namely a reciprocating movement, and minimise any lateral movement. The guide means may be as simple as a tongue provided on the fly screen mounting portion or the main body portion with a corresponding groove provided in the main or body portion of the actuation mechanism. Typically, the tongue and groove will extend substantially in the same direction as the direction in which the movement of the handle is allowed.

The clamping member is typically attached to the main or body portion of the actuation mechanism. The clamping member normally overlies a portion of the main or body portion but is spaced laterally from the main or body portion. Preferably, the clamping member and the main or body portion of the actuation mechanism will clamp at least a portion of the link member therebetween.

Attachment of the clamping member to the main or body portion of the actuation mechanism may be through the link member thereby providing a pivot point. According to a preferred embodiment, the link member may be provided as a unitary elongate member with at least one central opening therethrough, through which to receive a fastener which concurrently forms the pivot point and attaches the clamping member to the main or body portion of the actuation mechanism.

In an alternative embodiment, the clamping member may simply be a cover member and not perform any clamping function. In this case, the link may be attached to the main or body portion only, by a fastener.

Preferably, the main or body portion of the actuation mechanism will have sufficient dimension to cover the opening in the internally facing portion of the jamb when the handle is in either condition. In order to reduce material, the main body portion of the actuation mechanism, which is located adjacent the internally facing portion of the jamb, may be of greater dimension than the remainder of the main or body portion and/or the clamping member. Each of the main or body portion and the clamping member will preferably have a substantially triangular shape according to the most preferred embodiment as this will typically allow on minimisation of material used without a reduction in the strength of the mechanism.

An overcentre mechanism may be provided such that the handle may be moved into a temporary locked position which will typically minimise the chance of the opening of the louvre window through accidental rather than determined movement of the handle.

The majority of components in the actuation mechanism and the handle itself will typically be manufactured of strong plastic or light metal or similar may be used in the alternative.

In an alternative embodiment, the main body may be rectangular and preferably slides between the fly screen mounting portion and a U-shaped channel substantially parallel to the main mounting member. Typically, opposed edges of the main body will abut portions of the louvre window system in order to guide the reciprocal movement of the main body. The preferred rectangular shape will therefore preferably stabilise the movement of the main body.

The handle may be integrally formed with the main body but preferably, the main body will have at least one extension portion extending therefrom and having at least one engagement portion. The handle will preferably be formed as a pair of corresponding halves which are fixed to either side of the at least one extension portion and/or each other once the extension portion is inserted through the opening in the internally facing portion of the jamb.

A slide block bush may also be provided, associated with the handle and the main body. Typically, the slide block bush is placed into the groove defined by the fly screen mounting portion and the guide tongue with the extension portion of the main body extending through an opening in the slide block bush located adjacent the opening in the internally facing portion of the jamb. The slide block bush will preferably also assist with the guided movement of the handle.

The mechanism of this embodiment will preferably be provided with at least a pair of link arms. Typically, a first link arm is attached pivotally to the main body and the second link arm and a second link arm is attached pivotally to the first link arm and is also associated with at least one of the operating bars such that movement of the handle, moves the main body of the mechanism which in turn moves each of the link arms and ultimately at least one of the operating bars. The second link arm may be attached to at least one of the operating bars. The second link arm may be attached to both operating bars but typically, a third link arm is provided attached to both of the operating bars only.

The first link arm will typically be arcuate in shape between a first end and a second end. Preferably, the first link arm will also include a step along its length forming a pair of portions each of which are substantially parallel to the main mounting member but which are each spaced differently from the main mounting member.

A first end of the first link arm is typically connected pivotally to the main body and a second end of the first link arm is pivotally connected to the second link arm. The movement of the first end of the first link arm is preferably reciprocal and the movement of the second end of the first link arm will typically be arcuate, moving toward of the U-shaped channel when the handle is moved to the closed condition and away from the U-shaped channel when the handle is moved to the open condition.

The second link arm will preferably have a pair of portions which are angled with respect to one another, both of which are coplanar and substantially parallel to the main mounting member. Preferably, a portion of the second link arm extends through a slot opening in the U-shaped channel in order to be associated with at least one operating bar. The angled configuration of the second link arm will preferably give an over centre locking function to the mechanism.

The opening in the internally facing portion of the jamb may preferably be provided with finishing members or a finishing assembly. Preferably, an escutcheon member is provided along either side of the opening and a cap member provided at either end in order to frame the opening and increase the aesthetic appeal of the opening. Preferably, a portion of the handle will abut the finishing members and slide against them in use.

### BRIEF DESCRIPTION OF THE DRAWINGS

Various embodiments of the invention will be described with reference to the following drawings, in which:

FIG. 1 is an isometric view of a louvre window actuation system according to a preferred embodiment of the present invention in the open condition.

FIG. 2 is an alternative view of the louvre window actuation system illustrated in FIG. 1.

FIG. 3 is a side view of the louvre window actuation system as illustrated in FIG. 1 in the closed condition.

FIG. 4 is a side view of the louvre window actuation system illustrated in FIG. 1 in the open condition.

FIG. 5 is a front view from the inside of a louvre window system including the actuation system illustrated in FIG. 1, in the closed condition.

FIG. 6 is a front view of the louvre window system illustrated in FIG. 5, in the open condition.

FIG. 7 is a section view from above of the louvre window actuation system illustrated in FIG. 1, taken along line A-A illustrated in FIG. 5.

FIG. 8 is an isometric view of an alternative configuration of a louvre window actuation system of the present invention.

FIG. 9 is a section view from above of the louvre window actuation system illustrated in FIG. 8, taken along line B-B.

FIG. 10 is an isometric view of a louvre window actuation system according to a third preferred embodiment of the present invention in the closed condition.

FIG. 11 is an isometric view of a louvre window actuation system according to a third preferred embodiment of the present invention in the open condition.

FIG. 12 is a section view from above of the louvre window actuation system illustrated in FIGS. 10 and 11, taken along line C-C.

FIG. 13 is an axonometric view of a louvre window actuation system according to an alternative embodiment.

FIG. 14 is an alternative axonometric view of the liver window actuation system illustrated in FIG. 13.

FIG. 15 is a side view of the louvre window actuation system illustrated in FIGS. 13 and 14.

FIG. 16 is a section view from above of the louvre window actuation system illustrated in FIGS. 13 to 16, taken along line D-D in FIG. 15.

FIG. 17 is a section view from above of a modified louvre window actuation system having the same operative components as that illustrated in FIG. 16 but a slightly different configuration.

FIG. 18 is an exploded view of a louvre window actuation system according to an alternative embodiment.

### DETAILED DESCRIPTION OF THE PREFERRED EMBODIMENT

According to a particularly preferred embodiment, a louvre window actuation system is provided.

As illustrated in the accompanying Figures, the louvre window actuation system is used in association with a louvre window system having a plurality of louvre blades (not shown), a pair of operating bars 10 associated with each of the louvre blades for movement thereof, and a jamb 11 relative to which the louvre blades, and the operating bars 10 are mounted.

The jamb also includes a mounting portion 12 for mounting an internally mounted fly screen (not illustrated). The actuation system includes a slidable handle 13 movable between a closed condition in which the plurality of louvre blades are closed and a number of open conditions wherein the plurality of louvre blades are at least partially open. The slidable handle 13 is operatively associated with at least one of the operating bars 10 to actuate of the plurality of louvre blades. Importantly, the slidable handle 13 is located further internally on the jamb 11 than the mounting portion 12 for an internally mounted fly screen.

The preferred louvre window system includes a main frame comprising the head, sill and a pair of opposed jambs with a plurality of louvre blades extending substantially parallel to the sill and head. In the Figures, only a single jamb 11 is illustrated. Normally, only one jamb 11 will have a handle 13 and actuating mechanism.

The louvre blades are mounted in end clips 14 which hold the louvre blades.

The jamb 11 of the louvre window system of the illustrated embodiment includes a substantially U-shaped channel 15 into which is mounted the slidable operating bars 10. The channel engages with a portion of the jamb 11 in a snap-fit arrangement.

Each operating bar 10 is provided with a tooth profile which engages with a gear 16 provided in association with each louvre blade end clip 14. Therefore, movement of the operating bars 10 will normally drive rotation of the gear 16 which in turn moves the end clips 14 to open and close the louvre blades.

A link member 17 is provided through one wall of the substantially U-shaped channel 15 in which the operating bars 10 are located. This link member 17 engages both the handle 13 (indirectly) and at least one of the operating bars 10 (directly).

The link member 17 is pivotally mounted in order to move at least one operating bar 10 when the handle 13 is moved. Normally this pivoting movement is provided such that when the handle 13 is moved downward, the louvres open.

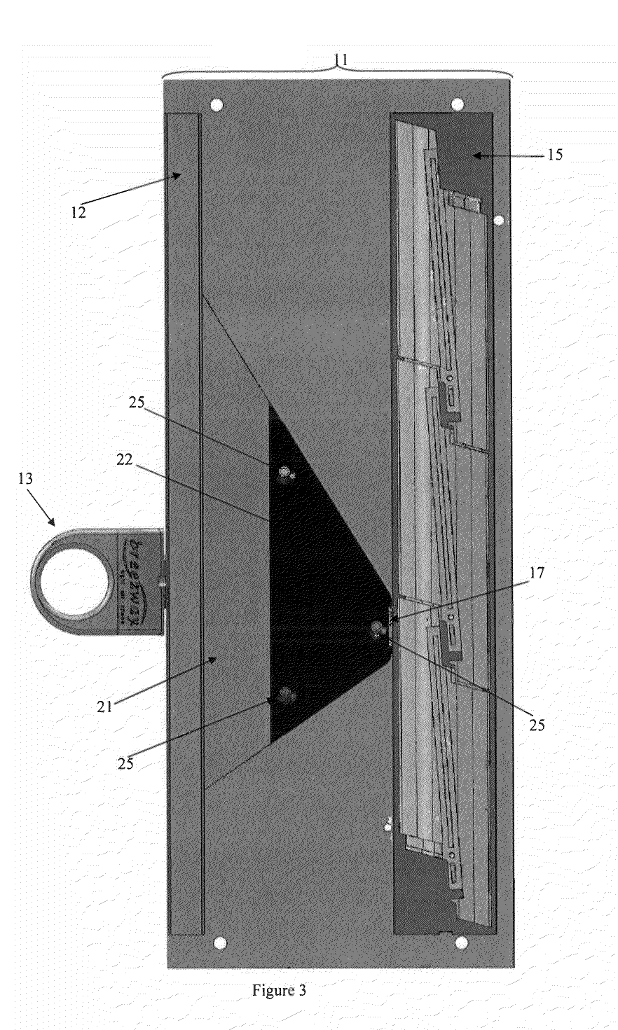

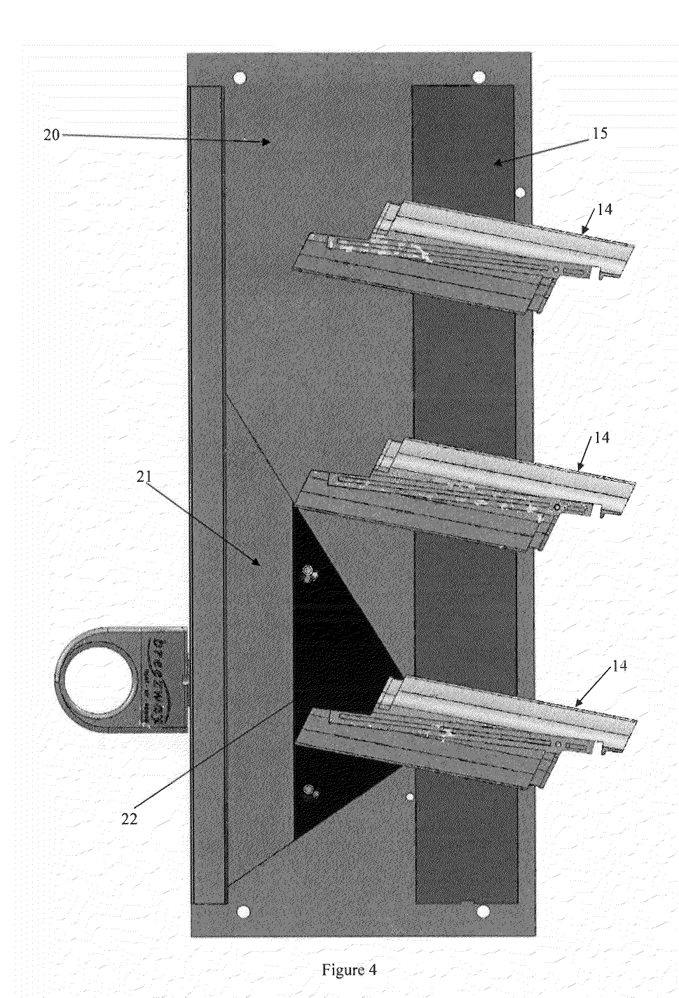

The slideable operating bars 10 are operated by pulling the handle 13 either up or down. In FIG. 3 for example, the handle 13 is in the up position and the louvres are closed, while in FIG. 4, the handle 13 is in the down position and the louvres are open.

The jamb 11 of the louvre window system of the illustrated embodiment includes an opening 18 in an internally facing portion 19 of the jamb 11 through which a portion of the handle mechanism protrudes. The internal handle 13 adapted for gripping is provided adjacent to the internally facing portion 19 of the jamb 11.

The jamb 11 of the window system of the preferred embodiment includes a main mounting member 20 which is adapted to be mounted adjacent the periphery of the opening into which the window system is to be secured. The substantially U-shaped channel 15 is adapted to engage with the main mounting member 20 and the louvre end clips 14 and operating bars 10 are mounted relative to the channel 15. A fly screen mounting portion 12 is spaced inwardly along the main mounting member 20 from the substantially U-shaped channel 15, typically by separation distance which is at least as large as half the height of a louvre blade or end clip 14.

The slidable actuation mechanism of the present invention of the illustrated embodiment is located between the substantially U-shaped channel 15 and a fly screen mounting portion 12 of the jamb 11. The slidable actuation mechanism is substantially parallel to the main mounting member 20 which separates the substantially U-shaped channel member 15 and the fly screen mounting portion 12.

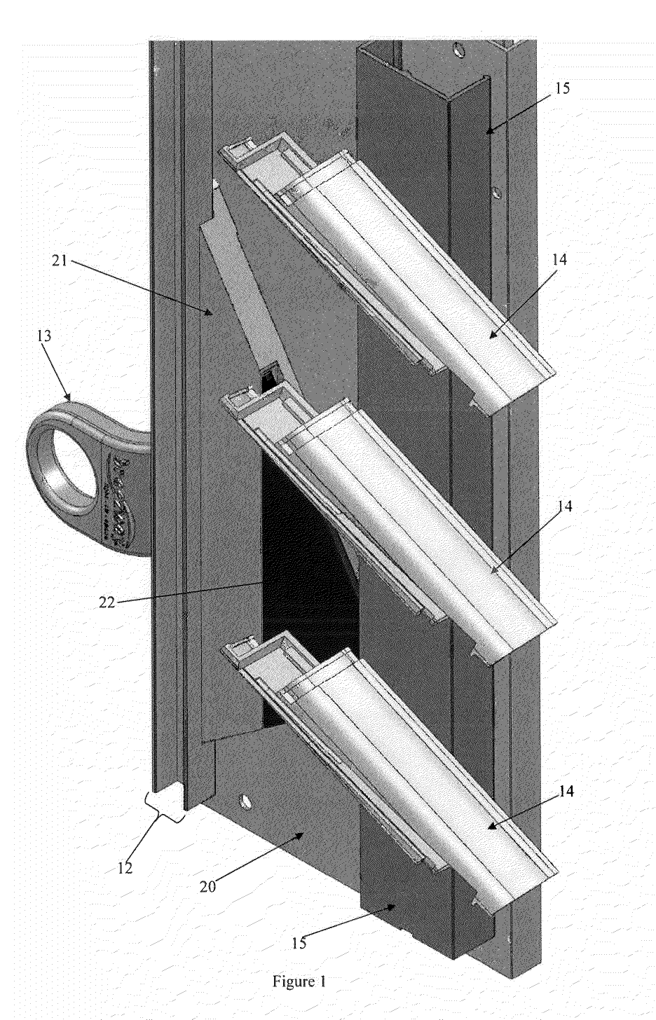

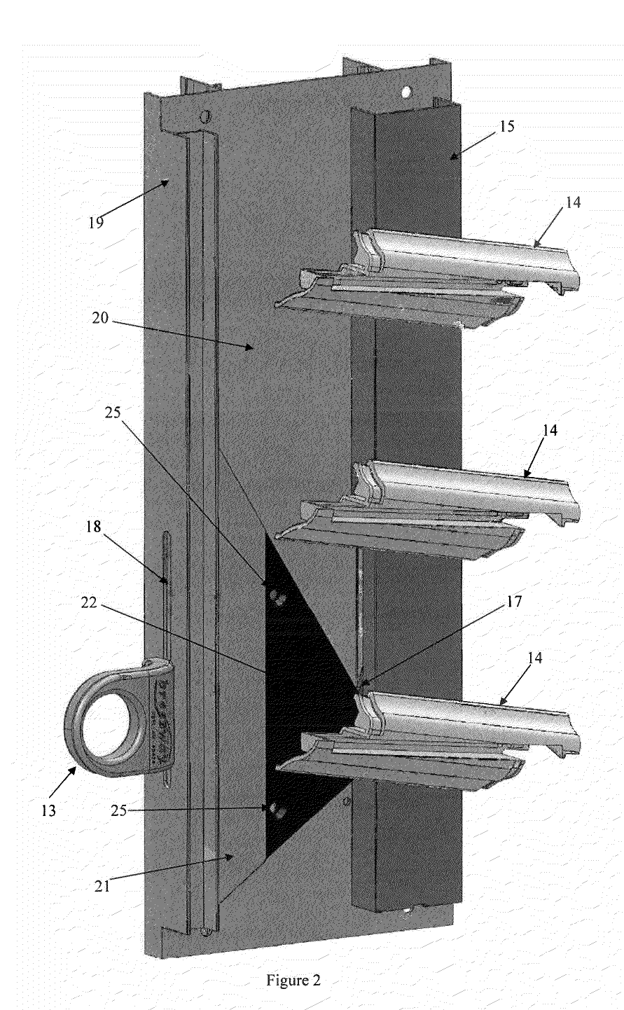

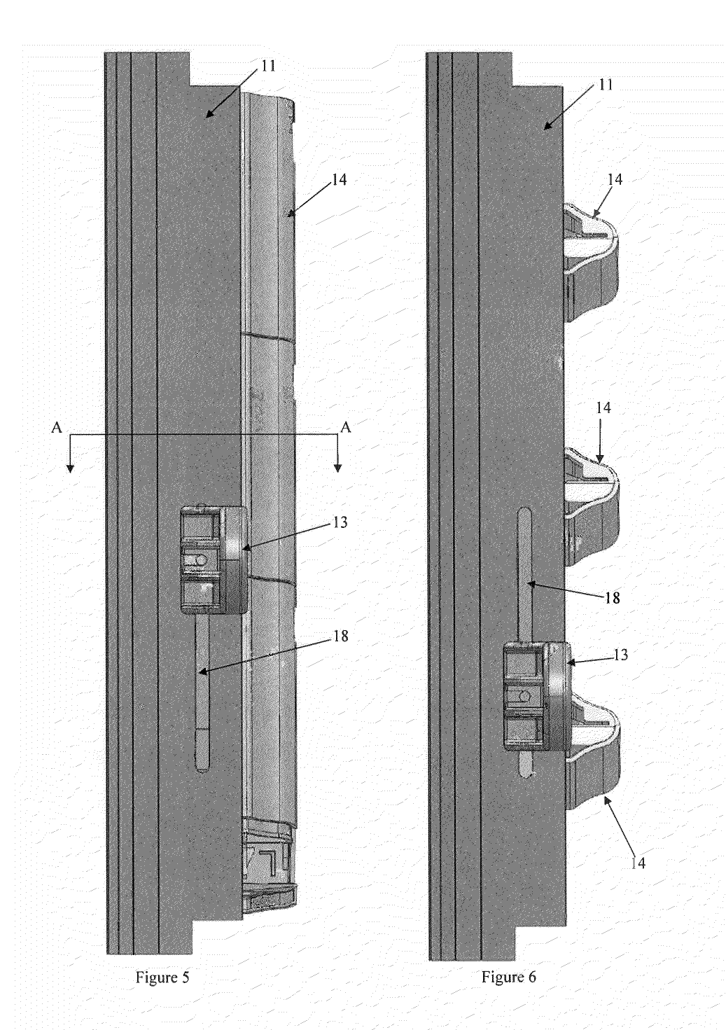

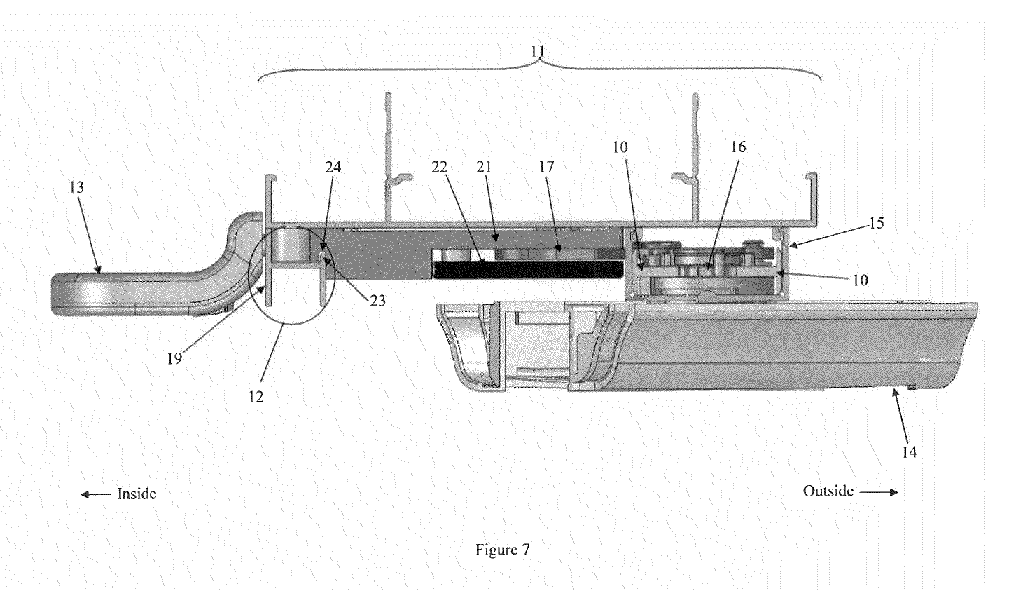

In the embodiment illustrated in FIGS. 1 to 7, the slidable actuation mechanism includes a main body 21 and a clamping member 22. The main body 21 is positioned to abut an internal surface of the internally facing portion 19 of the jamb 11 directly adjacent and over the opening 18 provided in the internally facing portion 19 which allows movement of the handle 13. In this way, the main body 21 of the actuation mechanism will also act to cover or seal the opening 18 provided in the internally facing portion 19 which will decrease the opportunity for ingress of insects or water for example through the jamb and into the room through this opening 18.

The fly screen mounting portion 12 acts as a guide portion for the main body 21 of the actuation mechanism. According to a particularly preferred embodiment as illustrated, the fly screen mounting portion 12 is adapted to mount a fly screen substantially perpendicularly to the jamb 11 of the window system. The fly screen mounting portion 12 is spaced from the main mounting member 20 which separates the substantially U-shaped channel member 15 and the fly screen mounting portion 12 from one another. A portion of the main body 21 is received into the space defined between the fly screen mounting portion 12 and the main mounting member 20 of the jamb 11 and helps guide the movement of the main body 21.

The received portion of the main body 21 may be of a different material to the remainder of the main body, of low friction or high strength material for example.

The fly screen mounting portion 12 is provided with guide tongue 23 which engages with a corresponding guide slot 24 provided on the main body 21 of the actuation mechanism in order to limit the movement of the main body 21 of the actuation mechanism to a single plane, namely a reciprocating movement and minimise any lateral movement. As illustrated, the tongue 23 and slot 24 extends substantially in the same direction as the direction in which the movement of the handle 13 is allowed.

The clamping member 22 is attached to the main body 21 of the actuation mechanism. The clamping member 22 is spaced from the main body 21 and clamps at least the portion of the link member 17 therebetween.

One of the attachment means which attaches the clamping member 22 to the main body 21 of the actuation mechanism extends through the link member 17 thereby providing a pivot point.

The main body 21 of the actuation mechanism has sufficient dimension to cover the opening 18 in the internally facing portion 19 of the jamb 11 when the handle 13 is in either condition.

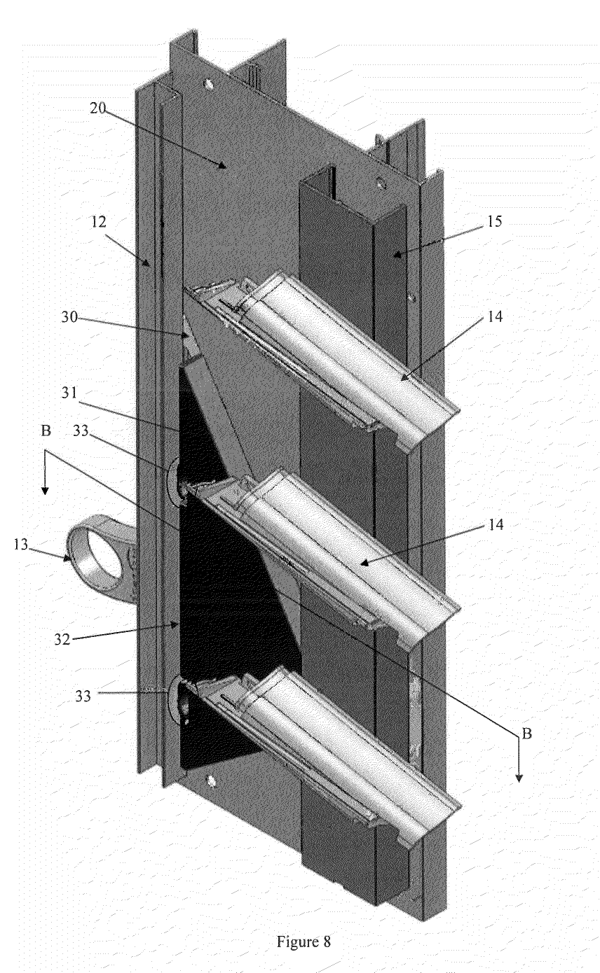

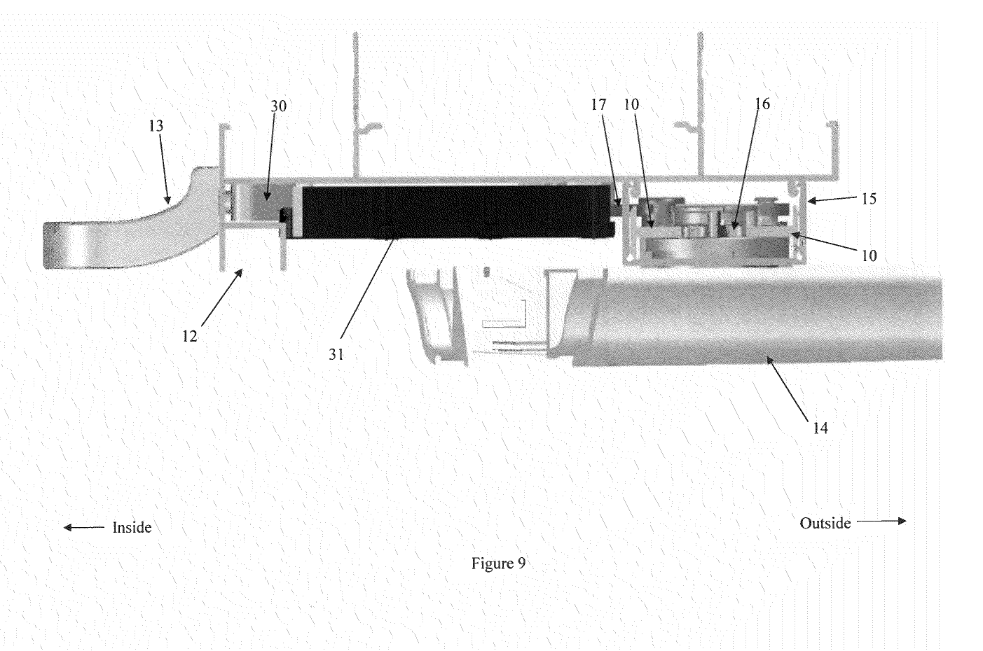

An alternative configuration of the louvre window actuation system of the present invention is illustrated in FIGS. 8 and 9.

In this illustrated embodiment, the slidable actuation mechanism includes a slide body 30 and an attachment member 31. The slide body 30 is attached to the slide handle 13 and positioned to abut an internal surface of the internally facing portion 19 of the jamb 11 directly adjacent and over the opening 18 provided in the internally facing portion 19 which allows movement of the handle 13. In this way, the slide body 30 of the actuation mechanism will also act to cover or seal the opening 18 provided in the internally facing portion 19 which will decrease the opportunity for ingress of insects or water for example through the jamb and into the room through this opening 18.

The fly screen mounting portion 12 still acts as a guide portion for the slide body 30 of the actuation mechanism. According to a particularly preferred embodiment as illustrated, the fly screen mounting portion 12 is adapted to mount a fly screen substantially perpendicularly to the jamb 11 of the window system. The fly screen mounting portion 12 is spaced from the main mounting member 20 which separates the substantially U-shaped channel member 15 and the fly screen mounting portion 12 from one another. A portion of the slide body 30 is received into the space defined between the fly screen mounting portion 12 and the main mounting member 20 of the jamb 11 and helps guide the movement of the slide body 30.

The attachment member 31 used positioned between the fly screen mounting portion 12 and the U-shaped channel 15 to slide upwardly and downwardly. In the illustrated embodiment, the attachment member 31 abuts both the fly screen mounting portion 12 and the U-shaped channel 15, and is therefore limited to movement in two directions only, namely up and down.

The interior edge 32 of the attachment member 31 is provided with a pair of resilient members 33 to assist with guiding the attachment member 31 during movement. These resilient members 33 will also assist with the security of the attachment member 31.

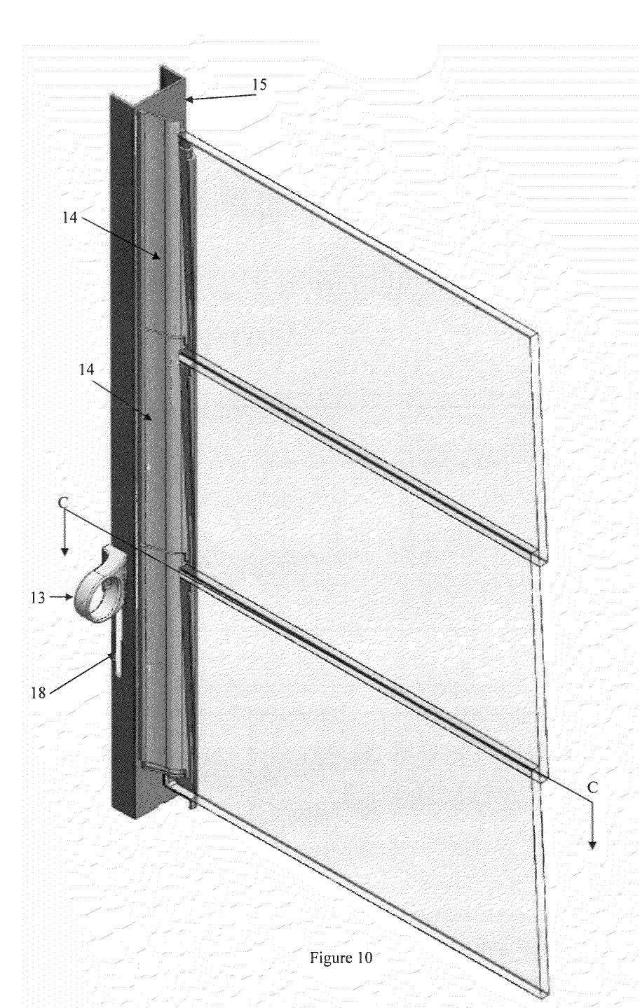

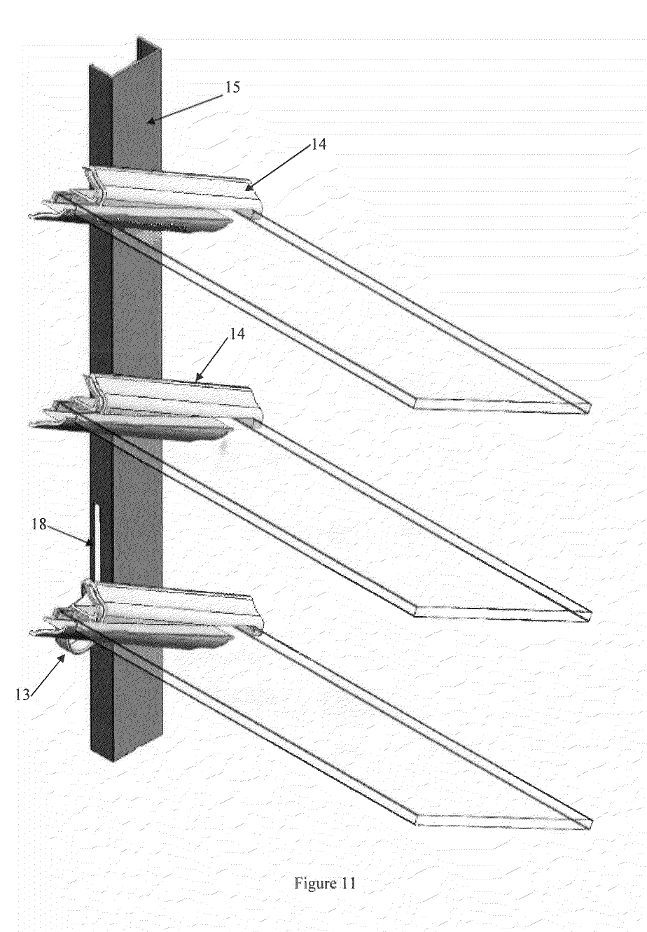

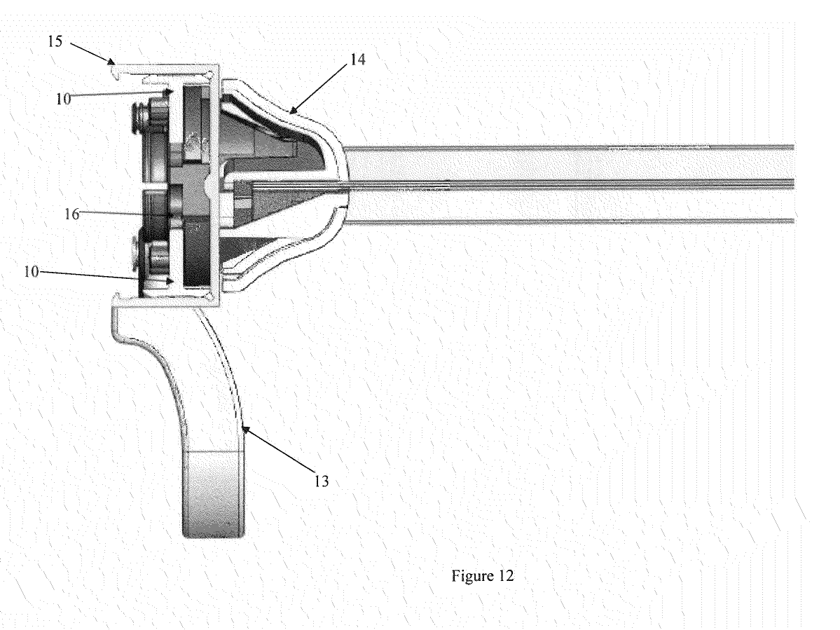

A third preferred embodiment of the louvre window actuation system of the present invention is illustrated in FIGS. 10 to 12 as applied to a louvre window system without an internal flyscreen mount.

As can be seen from the embodiment illustrated in FIGS. 10 to 12, the slide handle 13 is mounted directly adjacent to the U-shaped channel 15. According to this embodiment, the link member 17 of the earlier embodiment is not included, and the slide handle 13 is directly secured to one of the operating bars. Using this mechanism, a louvre window actuation system with a slide handle can be provided for a more conventional louvre window system in addition to that provided for a little window system having an internally mounted fly screen.

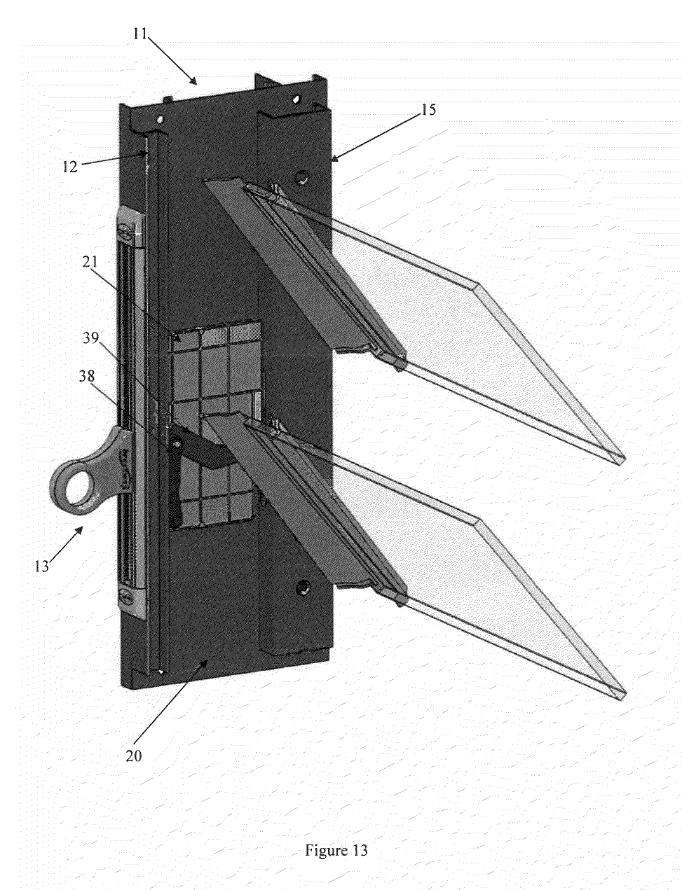

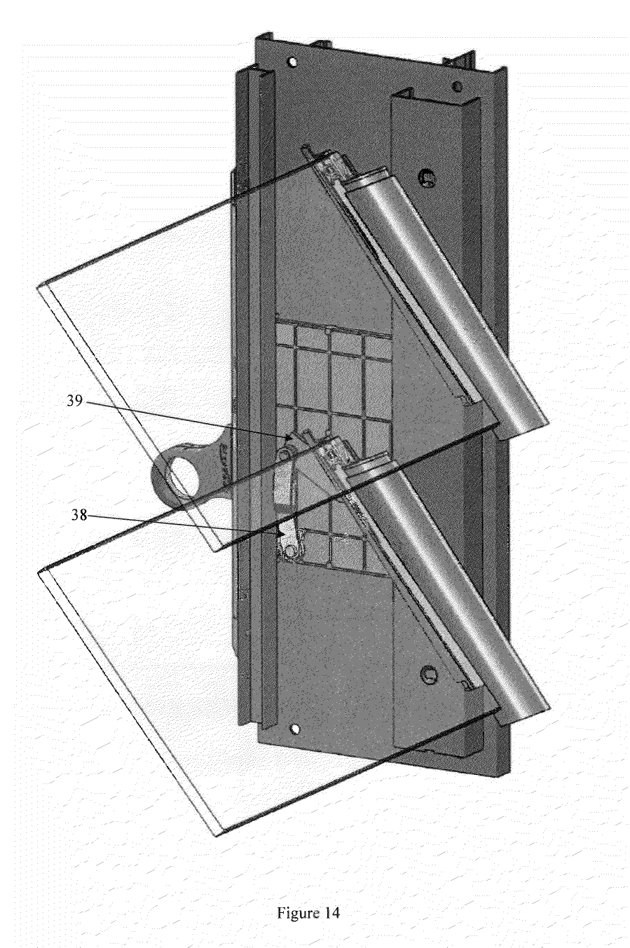

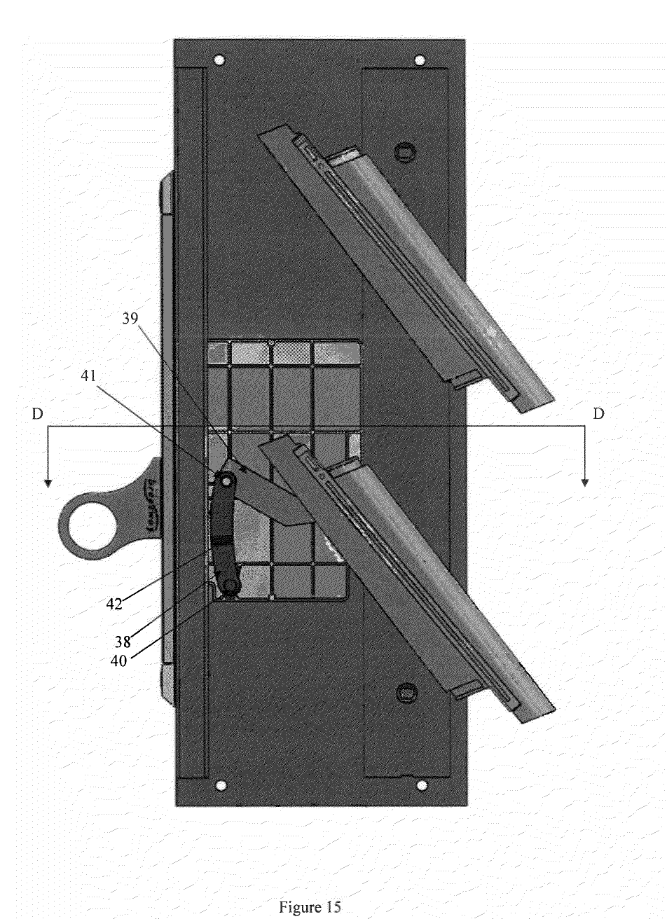

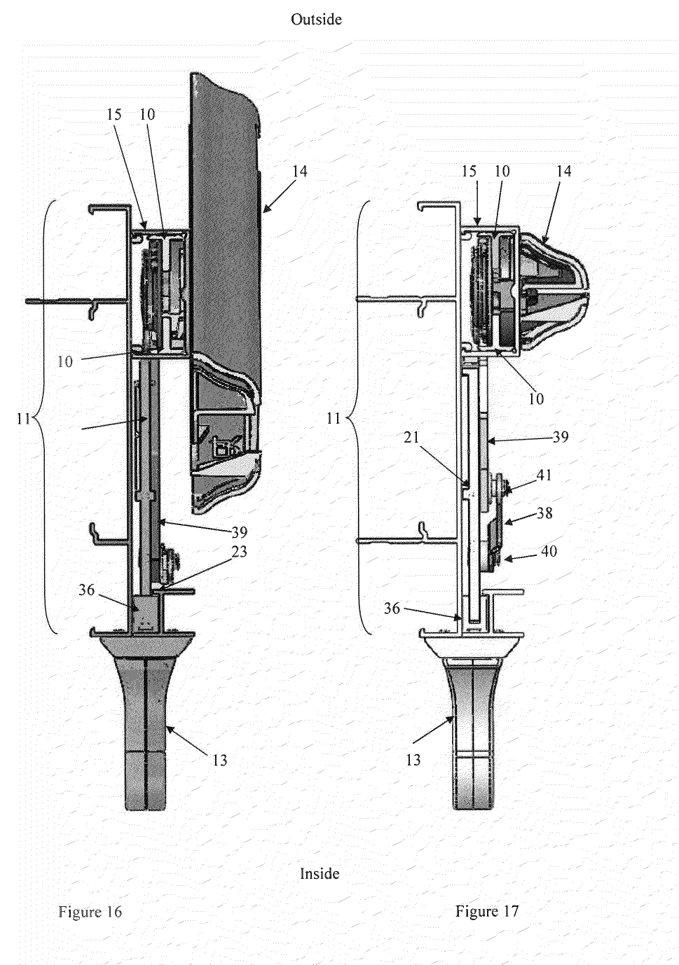

In an alternative embodiment illustrated in FIGS. 13 to 18, the main body 21 is rectangular and slides between the fly screen mounting portion 12 and the U-shaped channel 15 substantially parallel to the main mounting member 20. Opposed edges of the main body 21 abut portions of the louvre window system in order to guide the reciprocal movement of the main body 21.

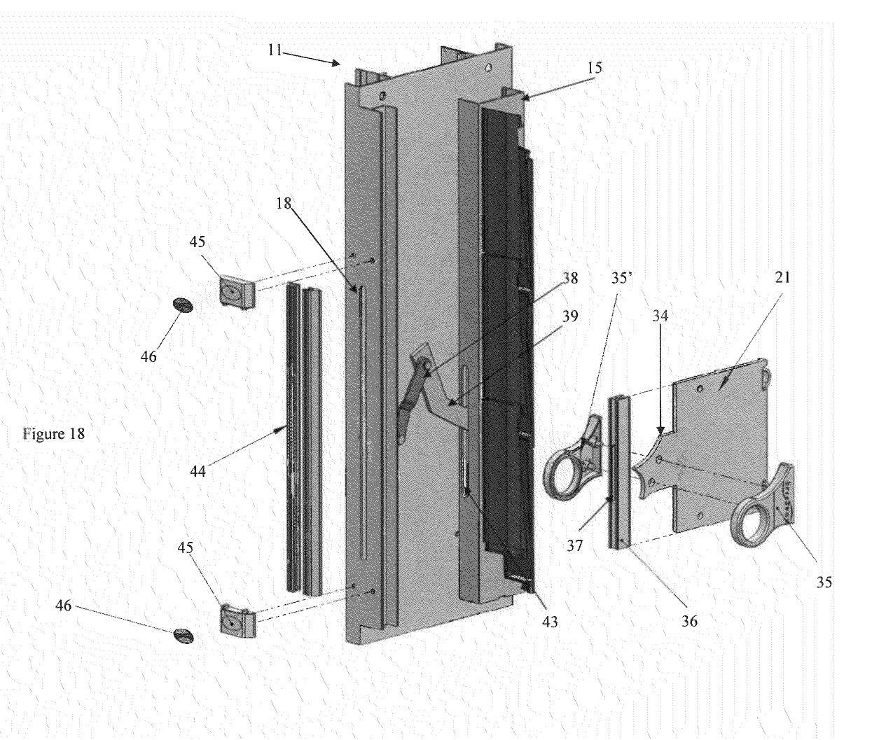

As illustrated in FIG. 18 most clearly, the main body 21 of this preferred embodiment has an extension portion extending therefrom with engagement openings. The handle 13 is formed as a pair of corresponding halves 35, 35′ which are fixed to either side of the extension portion 34 and each other once the extension portion 34 is inserted through the opening 18 in the internally facing portion 19 of the jamb 11.

A slide block bush 36 is also provided, associated with the handle 13 and the main body 21. The slide block bush 36 is placed into the groove defined by the fly screen mounting portion 12 and the guide tongue 23 with the extension portion 34 of the main body 21 extending through an opening 37 in the slide block bush 36 located adjacent the opening 18 in the internally facing portion 19 of the jamb 11.

The mechanism of this embodiment includes a pair of link arms. A first link arm 38 is attached pivotally to the main body 21 and a second link arm 39 and the second link arm 39 is attached pivotally to the first link arm 38 and is also associated with at least one of the operating bars 10 such that movement of the handle 13 moves the main body 21 of the mechanism which in turn moves each of the link arms 38, 39 and ultimately at least one of the operating bars 10 to move the louvre blades. The second link arm 39 may be attached to both operating bars but typically, a third link arm (not shown) is provided attached to both of the operating bars 10 within the U-shaped channel 15.

According to the embodiment illustrated, the first link arm 38 is arcuate in shape between a first end 40 and a second end 41. The first link arm also includes a step 42 along its length forming a pair of portions each of which are substantially parallel to the main mounting member 20 but which are each spaced differently from the main mounting member 20.

The first end 40 of the first link arm 38 is connected pivotally to the main body 21 and the second end 41 of the first link arm 38 is pivotally connected to the second link arm 39. The movement of the first end 40 of the first link arm 38 is reciprocal (upwards and downwards as illustrated) and the movement of the second end 41 of the first link arm 38 is arcuate, moving toward of the U-shaped channel 15 when the handle 13 is moved to the closed condition and away from the U-shaped channel 15 when the handle 13 is moved to the open condition.

The second link arm 39 has a pair of portions which are angled with respect to one another, both of which are coplanar and substantially parallel to the main mounting member 20. A portion of the second link arm extends through a slot opening 43 in the U-shaped channel 15 in order to be associated with at least one operating bar 10.

As illustrated in FIG. 18 in particular, the opening 18 in the internally facing portion 19 of the jamb 11 is provided with a finishing assembly. As illustrated, an escutcheon member 44 is provided along either side of the opening 18 and a cap member 45 provided at either end in order to frame the opening 18 and increase the aesthetic appeal of the opening 18. Branding decals 46 are provided on each cap member 45. In use, a portion of the handle 13 will abut the escutcheon members 44 and slide against them in use.

In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

1. A louvre window actuation system for a louvre window system having a plurality of louvre blades and at least one operating bar associated with each of the louvre blades for movement thereof, the actuation system including a slidable handle movable between a closed condition in which the plurality of louvre blades are closed and a number of open conditions wherein the plurality of louvre blades are at least partially open wherein the slidable handle is operatively associated with the at least one operating bar to actuate the plurality of louvre blades.

2. A louvre window actuation system for a louvre window system having a plurality of louvre blades, at least one operating bar associated with each of the louvre blades for movement thereof, and a jamb relative to which the louvre blades, and the at least one operating bar are mounted, the jamb also including at least one mounting portion for mounting an internally mounted fly screen, the actuation system including a slidable handle movable between a closed condition in which the plurality of louvre blades are closed and a number of open conditions wherein the plurality of louvre blades are at least partially open, the slidable handle operatively associated with the at least one operating bar to actuate of the plurality of louvre blades wherein the slidable handle is located further internally of the louvre window system than the at least one mounting portion for the internally mounted fly screen.

3. A louvre window actuation system for a louvre window system as claimed in claim 2 further including a jamb member and a substantially U-shaped channel associated with the jamb member to define a cavity in which the at least one operating bar is located.

4. A louvre window actuation system for a louvre window system as claimed in claim 3 including at least one link member associated with the handle and a portion of which extends into the substantially U-shaped channel in which the operating bars are located to engage at least one of the operating bars.

5. A louvre window actuation system for a louvre window system as claimed in claim 3 in which the jamb member includes an opening in an internally facing portion of the jamb through which a portion of the handle protrudes.

6. A louvre window actuation system for a louvre window system as claimed in claim 3 wherein the jamb member includes a main mounting member which is adapted to be mounted adjacent an opening into which a window system is to be secured, a substantially U-shaped channel member which is adapted to engage with the main mounting member and which mounts louvre end clips and at least one operating bar, and a fly screen mounting portion spaced inwardly from the substantially U-shaped channel by separation distance which is at least as large as half the height of a louvre blade or end clip to provide clearance to open the louvre window.

7. A louvre window actuation system for a louvre window system as claimed in claim 6 wherein a main body portion of the actuation mechanism is slidably moveable between the fly screen mounting portion and the substantially U-shaped channel.

8. A louvre window actuation system for a louvre window system as claimed in claim 7 wherein the main body has at least two opposed edges which slide between the fly screen mounting portion and a U-shaped channel substantially parallel to the main mounting member.

9. A louvre window actuation system for a louvre window system as claimed in claim 6 wherein the main body has at least one extension portion extending therefrom and having at least one engagement portion to engage at least one handle portion.

10. A louvre window actuation system for a louvre window system as claimed in claim 6 wherein the jamb includes a groove defined by the main mounting body and the fly screen mounting portion and a guide tongue extending laterally into the groove, the system further including a slide block bush associated with the handle and the main body received in the groove and slideable therein.

11. A louvre window actuation system for a louvre window system as claimed in claim 6 including at least a pair of link arms between the handle and the at least one operating bar.

12. A louvre window actuation system for a louvre window system as claimed in claim 11 wherein a first link arm is attached pivotally to the main body and a second link arm and a second link arm is attached pivotally to the first link arm and is associated with at least one of the operating bars.

13. A louvre window actuation system for a louvre window system as claimed in claim 12 wherein the second link arm is attached to at least one of the operating bars.

14. A louvre window actuation system for a louvre window system as claimed in claim 12 wherein the first link arm is arcuate in shape between a first end and a second end.

15. A louvre window actuation system for a louvre window system as claimed in claim 14 wherein the movement of a first end of the first link arm is reciprocal and the movement of a second end of the first link arm is arcuate, moving toward of the U-shaped channel when the handle is moved to a closed condition and away from the U-shaped channel when the handle is moved to an open condition.

16. A louvre window actuation system for a louvre window system as claimed in claim 12 wherein the second link arm has a pair of portions which are angled with respect to one another, both of which are coplanar and substantially parallel to the main mounting member.

17. A louvre window actuation system for a louvre window system as claimed in claim 12 wherein a pair of operating bars are provided and a third link arm is provided attached to both of the operating bars.

18. A louvre window system including a plurality of louvre blades, at least one operating bar associated with each of the louvre blades for movement thereof, a slidable handle movable between a closed condition in which the plurality of louvre blades are closed and a number of open conditions wherein the plurality of louvre blades are at least partially open, the slidable handle operatively associated with the at least one operating bar to actuate of the plurality of louvre blades, a jamb adapted to mount the louvre blades, the at least one operating bar and a slidable handle, the jamb also having at least one mounting portion for mounting an internal fly screen on an internal side of the window system, wherein the slidable handle is located further internally of the louvre window system than the at least one mounting portion for an internally mounted fly screen.
